(19) United States
(12) Patent Application Publication
(10) Pub. No.: US 2009/0212064 A1
(43) Pub. Date: Aug. 27, 2009

(54) TRANSPORT SYSTEM FOR BLISTER PACKAGES OR THE LIKE

(75) Inventors: Kai Beilenhoff, Grasellenbach (DE); Klaus Schmid, Neulussheim (DE); Oliver Stuke, Heidelberg (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 12/390,047

(22) Filed: Feb. 20, 2009

Related U.S. Application Data
(60) Provisional application No. 61/030,631, filed on Feb. 22, 2008.

(51) Int. Cl. G07F 11/58

(52) U.S. Cl. 221/85; 221/217

(57) ABSTRACT

The invention is directed to a transport system for blister packages or the like, with a boom for mounting on a vertical wall or the like. Guided in the boom is a finite chain formed of hooks such that it is slidable by hand out of a lower groove section via a turning point into an upper groove section and vice versa, within guide grooves extending along the two groove sections and the turning point. Blister packages or the like which are suspended from the hooks can be removed by hand only in the region of the turning point. Preceding and following the turning point, there is formed between each pair of neighboring hooks a closed compartment which opens only in the region of the turning point for removal of a blister package or the like, so that only one blister package at a time can be removed from the chain. With the removal of each blister package or the like, the chain is advanced one step to the front, whereby a neat shelf profile is maintained automatically.

### CROSS-REFERENCE TO RELATED APPLICATIONS

This application claims the benefit under 35 U.S.C. §119(e) of Provisional Application Ser. No. 61/030,631 filed on Feb. 22, 2008, entitled TRANSPORT SYSTEM FOR BLISTER PACKAGES AND THE LIKE and whose entire disclosure is incorporated by reference herein.

### BACKGROUND OF THE INVENTION

1. Field of Invention

The present invention relates to transport systems and, more particularly, to transport systems for blister packages or the like.

2. Description of Related Art

Blister packages are very popular on account of their ease of handling at the point of sale. Nearly all products are offered in such blister packages provided they are suitable in terms of their nature, size and weight. The presentation of such blister packages is effected by hanging the blister packages on supporting arms which are constructed as freely protruding booms and fitted in spaced relation in rows and columns on a perforated wall or the like. In this way, entire assortments of merchandise can be offered for sale in a relatively clearly arranged manner.

The biggest problem of such merchandise assortments offered in blister packages is that a homogenous presentation of the merchandise assortment cannot be guaranteed because of the irregular sale of individual products. The products hanging in the rear rows can no longer be well recognized when the front products are missing as the result of being sold, because they find themselves in a channel which is formed by the blister packages to the sides and cannot be looked into. The clear arrangement is lost in this case and the uniform presentation which exists when the supporting arms are fully loaded is permanently disturbed. A homogeneous presentation of the blister packages requires the blister packages hanging at the rear to be pushed to the front by sales staff from time to time in order to restore a uniform shelf profile. Because this is cumbersome and labor-intensive, a way of performing this task automatically has been long sought.

Standard blister packages are comprised of a sturdy card made of paperboard having welded to or slipped on the front a transparent blister foil. Sandwiched between the two are the products to be vended. In addition, conventional blister packages have a standardized hole, at least in Europe where it is called the “Euro hole,” for suspending the package upon the supporting arm. On the same lines as this standard blister package, there are countless packaging variants in the form of bags, nets and boxes made of plastic or paperboard whose similarity is limited only to the Euro hole for suspension. But even this quasi-standardized Euro hole is designed differently by many suppliers. At the same time, there are also products which have a hole or Euro hole or the like of their own (e.g., dishwashing brushes) and therefore require no packaging at all but can still be presented suspended upon a boom. Products of such type are likewise covered by the term “blister package or the like” as herein used.

To perform the task automatically of guaranteeing a homogeneous presentation even when blister packages or the like are removed, there are two different techniques for ensuring that packages hanging at the rear are automatically transported to the free end of the supporting arm. With the first technique, each of the supporting arms is assigned one spring-loaded pusher which pushes the remaining packages as far as the limit in the delivery zone each time one of the packages hanging on the supporting arm is removed in the delivery zone by a customer. Up to now there is no really satisfactory spring system able to effect this forwarding of the products without disturbance. The known spring systems enable only the mounting of accurately coordinated packages and work without disturbance only as long as nothing changes on the packages. Furthermore, the removal of products by the customer is hardly user-friendly. The package has to be freed from the system more or less with force. Under the pressure of the spring-loaded pusher the packages tend to skew. Desirably, the customer effects the automatic forwarding of the packages himself by removing the product, but if the customer removes a package unintentionally or removes the wrong package and wants to slip it back onto the supporting arm again, then he will experience considerable problems with today's usual package transport systems.

With the second technique, it is not the customer himself who removes the front package or the like and, with the removal, effects automatically the forwarding of the packages hanging behind, but rather each supporting arm is equipped with an endless chain which is routed over two chain sprockets and has chain links each equipped with one hook element for the suspended transportation of a package or the like. One of the chain sprockets is driven by a motor. This technique, with which the forwarding of the packages is no longer effected manually by the customer but at most “by pushbutton” is used solely on automatic vending machines. Such a transport system, on which the preamble of claim 1 is based and on which furthermore the chain links are guided in a lower guide groove section of the boom or supporting arm, is known, for example, from U.S. Pat. No. 3,780,909 (Callahan, et al.).

In this known transport system, the endless chain includes a plurality of rigid chain links which are connected by pins in order to define pairs of retention elements. Each pair of retention elements is formed by two adjacent chain links. The two chain links of each pair are differently constructed, namely as a so-called anvil member and as a so-called wedge member. These two members of each pair co-act together such that they releasably retain a package or the like between them.

As soon as one chain link pair reaches the turning point and moves upwards, the two chain links of the pair separate from each other and release the package or the like in question, which then leaves the chain under the action of gravity and drops normally into a merchandise chute for removal by the purchaser. After the turning point the upper chain run advances, hanging freely between the two chain sprockets, until it is deflected again at the other chain sprocket in order, at the end opposite the turning point, to re-enter the lower groove section in which the chain is linearly guided as far as the turning point at which the packages or the like are released.

Obviously, this second technique is complex and capital-intensive. It is not used therefore for transport systems which are freely accessible to the customer but in automatic merchandise vending machines or glass cases which bar the customer from direct access to the merchandise and are therefore also suitable for use in connection with high-priced products. High-priced products would include, for example, printer cartridges and printer paper, memory cards, high quality toiletries, razor blades and generally expensive brand products. Otherwise it is possible with the second technique to guarantee a trouble-free presentation and dispensing of merchandise, but it is unsuitable for presenting and dispensing mass-produced articles.

Other examples of the use of this second technique in automatic vending machines are shown in U.S. Pat. No. 3,716,165 (Patrick); U.S. Pat. No. 3,756,455 (Patrick); U.S. Pat. No. 3,757,993 (Bruckneretal.) as well as DE 2033536 (Forrington) and EP 1081663 (Suzuki).

All references cited herein are incorporated herein by reference in their entireties.

### BRIEF SUMMARY OF THE INVENTION

It is an object of the present invention to improve a merchandise transport system of the type initially referred to such that it enables in a simpler manner a seamless presentation, removal and returning of the merchandise.

This object is accomplished according to the invention on the basis of a transport system of the type initially referred to in that the chain is a finite chain, in that the lower groove section is part of at least one guide groove subsequently extending via the turning point and an upper groove section and back in the direction of the mounting end, and in that the chain and the boom are constructed so that for removing blister packages or the like the chain is movable by hand out of the lower groove section via the turning point into the upper groove section, and for loading blister packages or the like it is movable by hand back into the lower groove section.

The transport system according to the invention unites the functions of shelf arrangement and product presence. In addition, the transport system according to the invention unites the advantages of the two known techniques while avoiding the disadvantages of both. In the transport system of the invention, packages or the like are removed by hand while the following packages are advanced simultaneously. This is made possible by using a finite chain which obviates the need for a sprocket and is advanced one step by hand with each removal of a package while being moved one step back when packages are replenished. The transport system of the invention is therefore also independent of the construction of the hooks. It is also superfluous and undesirable to accommodate the transport system of the invention in a glass case or the like. On the contrary, it should be freely accessible for the customer and make merchandise security through presentation in glass cases superfluous. When the customer removes the front blister package or the like, through the removal he automatically effects the advancing of the packages or the like hanging behind, as the result of which a spring-loaded forwarding system as with the first known technique or a motorized drive as with the second known technique can be dispensed with. Furthermore, in the transport system according to the invention the chain can be made from identical chain links, which greatly simplifies the chain design. The arrangement is suitably selected such that the package or the like can be removed by hand, meaning that it does not drop under the effect of gravity, at the turning point when two neighboring chain links, between which there is a package or the like, move apart from each other.

The subject-matter of the claims forms advantageous embodiments of the transport system according to the invention.

If in an embodiment of the transport system according to the invention the boom has a casing which is constructed as a hollow body open in a downward direction and which is equipped on the inner side of its mutually opposite longitudinal walls with the respective guide groove, then in the presentation of merchandise only the boom with its casing, on whose lower side the blister packages or the like are visible neatly arranged one behind the other in rows, is perceivable by the eye. Not only does this result in an aesthetically attractive appearance of the transport system, but the actual chain is also placed out of reach of the customer, thus fulfilling aspects of security.

If in another embodiment of the transport system according to the invention the casing is split longitudinally, forming two shells, then the casing is easier to manufacture.

If in another embodiment of the transport system according to the invention the shells of the casing have means for a mutual plug-in connection, then the assembly of the casing and the chain in the casing is particularly easy. The two casing shells can be fixed in an accurately aligned relationship to each other by means of the plug-in connection during the assembly. The casing shells and hence the casing can be manufactured in different lengths. For this, it is possible to use a variable-length injection mold. Different lengths are dependent in this case on a technically necessary grid and are not freely selectable.

If in another embodiment of the transport system according to the invention the boom has a supporting arm mountable on a fixed structure (e.g., a wall or the like), for the casing, then the supporting arm, which can be made from steel, provides the stability of the system in a longitudinal direction and transfers the forces to the fixed structure, preferably via a mounting plate which is attached to the end of the supporting arm and with which the supporting arm is suspended, for example, on a perforated wall of a shelf. The two prior assembled casing shells can be secured together (e.g., screwed) with the supporting arm after the chain is introduced. The integrated design enables an easy adaptation of the supporting arm lengths to the different lengths of casing shells within the predetermined grid. After assembly of the two casing shells, the shells form a stable profile with mutually aligned guide grooves in which the chain is exactly aligned in the longitudinal and transverse directions.

If in another embodiment of the transport system according to the invention each chain link and its hook element are constructed as a single-piece hook, then the chain link and the hook element can be manufactured as an injection molded part particularly economically in a single operation.

If in another embodiment of the transport system according to the invention each hook has on one end a clip mounting portion adapted to be clipped into the clip mounting portions of two neighboring hooks, then the hooks can be joined very easily to form a finite hook chain on which the number of hooks correlates with the length of the two casing shells. As the result, the transport system according to the invention can be executed very easily in a grid of different lengths and according to the desired number of blister packages or the like.

If in another embodiment of the transport system according to the invention each clip mounting portion has a guide pin and, parallel and complementary thereto, a slotted bushing into which the guide pin of a neighboring hook can be clipped, then a finite hook chain can be assembled and disassembled in a simple manner without any tools and without any additional fastening elements.

If in another embodiment of the transport system according to the invention each guide pin has at either end protruding guide journals for being received in the guide groove(s), then each chain can be slidingly guided easily and jerk-free in opposed grooves in the casing shells. Conveniently, both the casing shells and the chain are made from plastic, so that suitable material combinations afford further advantages with regard to smooth running properties. In addition, the chain is secured in a simple manner against slipping out of the guide grooves.

If in another embodiment of the transport system according to the invention each hook has on the other end for forming the hook element a portion cranked on one side, then an accordingly suitable hook for each thickness of blister package or the like can be selected by selecting the length of the cranked portion. For thicker blister packages or the like it is necessary only to select a hook with a longer cranked portion.

If in another embodiment of the transport system according to the invention lateral webs are constructed on the cranked portion, then these webs serve to receive and stabilize the blister packages or the like. The lateral webs support the blister packages or the like inside the Euro hole such that the blister packages or the like always hang vertically and sideways shifting or crooked hanging of the packages is prevented. The appearance of the blister packages or the like hanging one behind the other is essentially positively influenced as the result.

If in another embodiment of the transport system according to the invention each hook has at the other end on the side opposite its cranked portion a recess for receiving the free end of the cranked portion of a neighboring hook, then each two neighboring hooks of the finite chain can combine to form a closed compartment for accommodating the upper end of a blister package or the like. This compartment remains closed during the advancing of the chain and does not open until within the deflection zone. It is thus assured that a blister package or the like can be removed from the chain only in the deflection zone. The blister packages or the like are securely held therefore by their hole or Euro hole and cannot drop accidentally out of the system. The removal of a blister package or the like is possible only within the deflection zone in which the intermeshing hook elements open. On removal of the front blister package or the like, the subsequent packages or the like are automatically pulled forward as the result of the gentle sliding of the chain. The subsequent, forward-orientated blister package or the like is then ready at the free end of the boom for the next removal. Replenishment of the transport system takes place in reverse order. During replenishment, the blister packages or the like are hung into the next possible hook elements depending on thickness. Because the chain is pushed back simultaneously, the blister packages or the like suspended upon the chain are securely held.

If in another embodiment of the transport system according to the invention the hooks are guided at an angle through the guide groove(s) and on each hook the clip mounting portions are set at a corresponding angle relative to the hook elements, then the result is a shallow and aesthetically pleasing construction of the boom even though the upper groove section and the lower groove section for guiding the finite chain are arranged one above the other.

If in another embodiment of the transport system according to the invention separate links are available which are constructed like every clip mounting portion, then neighboring hooks can be connected by links. This enables hooks with longer cranked portions required for thicker blister packages or the like to be moved without difficulty over a turning point having a small curvature radius. A chain link pitch as large as the length of the cranked portion would require a significantly greater curvature radius in the reversal area. This would result in an increased height of the two casing shells, and the looks of the transport system would be impaired. The hooks with a long cranked portion and the links can be joined together to form a finite chain just as simply as hooks without such links. The links compensate for the length difference of the cranked portions of the hooks without affecting the actual chain pitch with regard to the small curvature radius in the reversal area. The chain thus has the short pitch at the top in the guide but the long pitch in the lower region of the hooks, that is, in the region of the cranked portions of the hooks. As the turning point of the free end of the long cranked portion does not change in relation to the hook with a short cranked portion, hooks with a long cranked portion can also be deflected in the casing shells whose dimensions orientate themselves by the chain having hooks with a short cranked portion.

If in another embodiment of the transport system according to the invention each hook is equipped with at least one switching cam for actuating a motion detector or the like, then a state of motion or other states of the chain (for example, its advancing or receding motion) can be detected.

### BRIEF DESCRIPTION OF SEVERAL VIEWS OF THE DRAWINGS

The invention will be described in conjunction with the following drawings in which like reference numerals designate like elements and wherein:

FIG. 1 is a partial side view of a preferred embodiment of a transport system according to the invention, which is intended for blister packages or the like;

FIG. 2 shows the detail of a chain of the blister package transport system of FIG. 1 in a side view but depicting the chain inclined in relation to FIG. 1 so that guide pins of the hooks forming the chain are oriented horizontally;

FIG. 3a is a side view of a hook of the transport system of the present invention;

FIG. 3b is an isometric view of the hook of the present invention;

FIG. 3c is another isometric view of the hook of the present invention taken from the opposite side of the hook shown in FIG. 3a;

FIG. 4 shows the manner of assembling a finite chain of hooks shown in FIGS. 3a-3c;

FIG. 5 shows the assembly of a chain according to a second preferred embodiment of hooks and links;

FIG. 6 is a view of the blister package transport system according to FIG. 1 showing a casing of a boom in a cross-sectional view, a hook in a front view as in FIG. 3a and a hook in a back view as in FIG. 3c;

FIG. 7 is a view of a shell of a casing of a boom of the blister package transport system according to FIG. 1;

FIG. 8 is a view of a second shell of the casing which fits the shell of FIG. 7;

FIG. 9 shows the manner of connecting the shells of FIGS. 8 and 9 by means of a plug-in connection;

FIG. 10 is a view of a casing formed from the plug-connected shells of FIGS. 7 and 8 together with a supporting arm of said casing; and

FIG. 11 is a view of a third preferred embodiment of a hook which is equipped with switching cams.

### DETAILED DESCRIPTION OF THE INVENTION

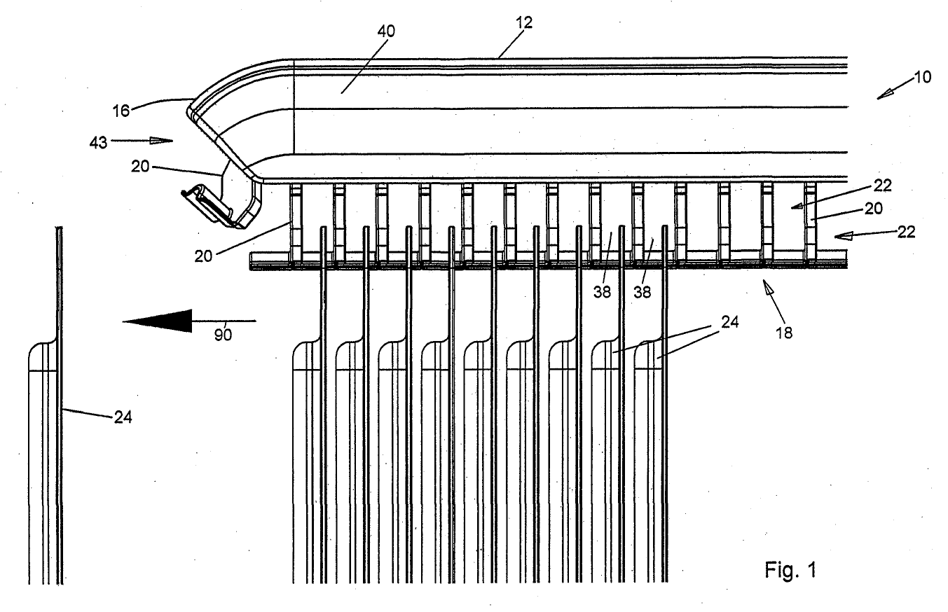

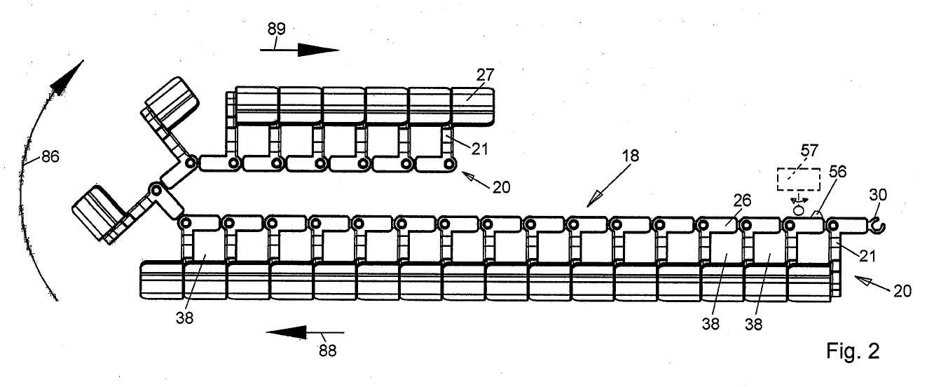

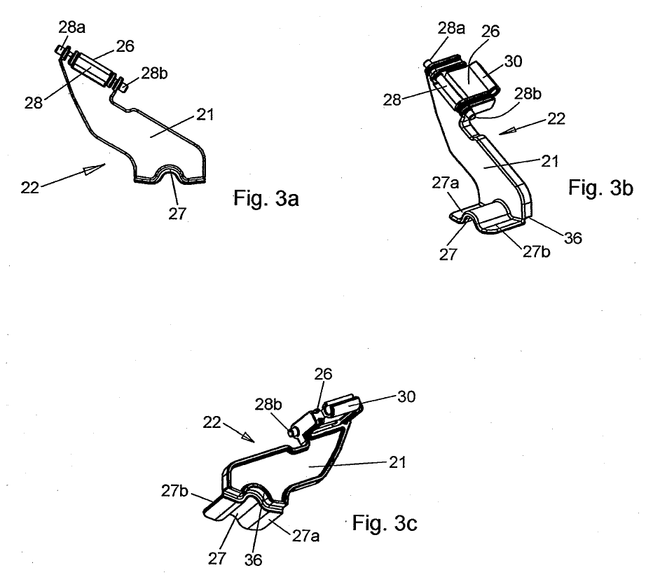

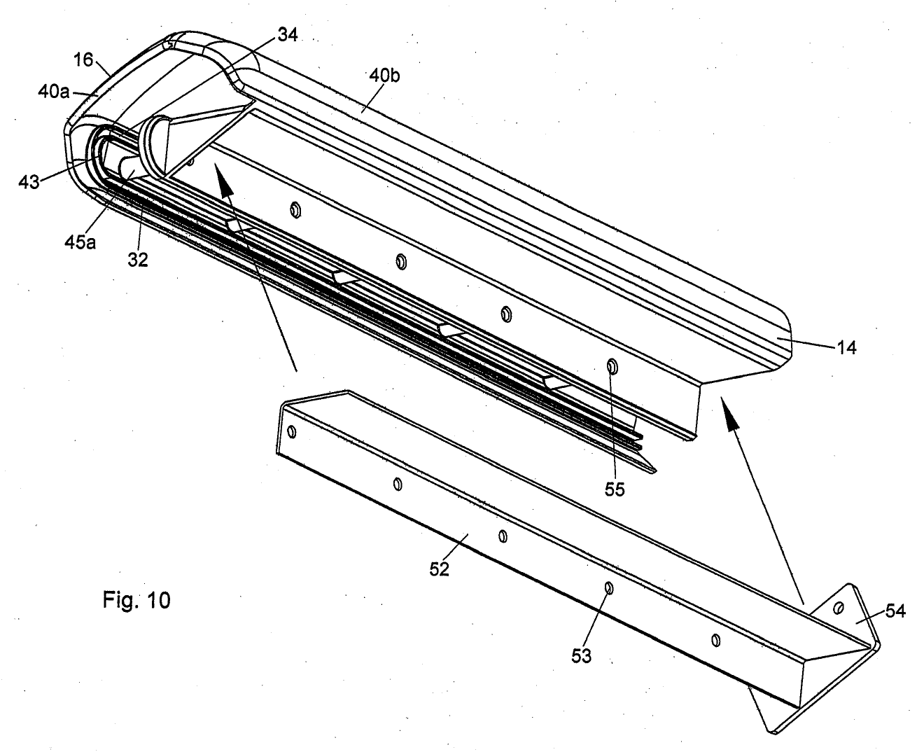

FIG. 1 shows in a partial side view a preferred embodiment of a transport system, generally designated as 10, according to the invention, which is intended for blister packages. The blister package transport system 10 has a boom 12 which has a mounting end 14 (FIG. 10) for mounting on a fixed structure (e.g., a vertical wall, not shown) and a free end 16 opposite thereto. Furthermore the blister package transport system 10 has a finite chain 18 formed from chain links 20. Shown in FIG. 2 as a detail is the chain 18 of the blister package transport system 10 of FIG. 1. FIG. 3 shows in a side view in FIG. 3a, in a perspective oblique view from above in FIG. 3b, and in a perspective oblique view from below in FIG. 3c a first preferred embodiment of a hook 22 of the blister package transport system 10. Each chain link 20 of the chain 18 is equipped with an integrally formed hook element 21 for the suspended transportation of a blister package 24. The arrangement of the blister packages 24 during the suspended transportation becomes apparent from FIG. 1 in which neither the boom 12 nor the blister packages 24 are shown in full length.

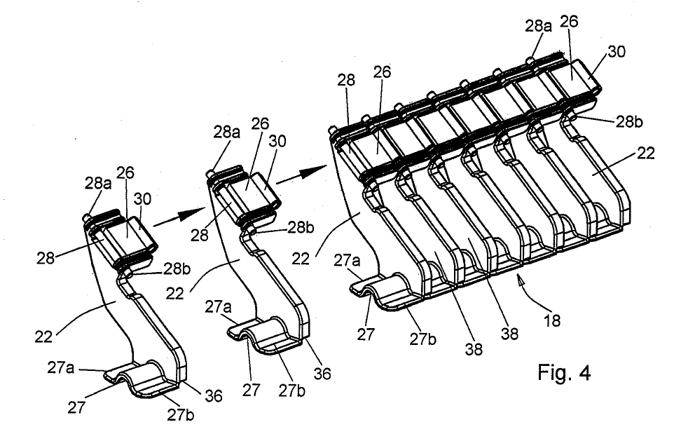

According to the representation of FIGS. 3a-3c, each chain link 20 and its hook element 21 are constructed as a single-piece hook 22. Each hook 22 has on one end (e.g. situated top left in FIG. 3a) an integrally formed clip mounting portion 26 which can be clipped into the identically constructed clip mounting portions 26 of two neighboring hooks 22 in the manner shown in FIG. 4. In this way it is possible to assemble from identical hooks 22 the finite chain 18 which is shown as a detail in an overall view in FIG. 2.

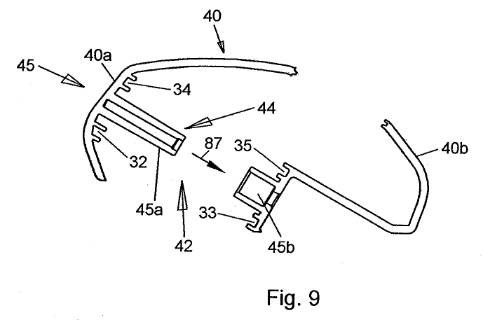

According to the representation of FIG. 3-4, each clip mounting portion 26 has a guide pin 28 and, parallel and complementary thereto, a slotted bushing 30 into which the guide pin 28 of a neighboring hook 22 can be clipped. Each guide pin 28 has at either end thereof protruding guide journals 28a, 28b to be received in guide grooves 32, 33 and 34, 35 in a casing 40 (FIG. 9) which will be described in more detail in the following. Each hook 22 has on its other end, that is, on its end opposite the clip mounting portion 26, a portion 27 which is cranked on one side for forming or completing the hook element 21. In the first preferred embodiment of the hook 22 herein described, the cranked portion 27 is integrally formed on a longitudinal bar of the hook element 21, which extends downwards from the clip mounting portion 26 in the representation of FIG. 3. Conveniently, each hook 22 is formed from plastic in a single piece as an injection molded part. Formed on the cranked portion 27 are lateral webs 27a, 27b which serve to receive and stabilize the blister package 24 suspended upon the cranked portion 27 of the hook 22 in that they support the blister package within a Euro hole such that the blister package always hangs vertically and sideways shifting or crooked hanging of said package is prevented, as initially mentioned. A Euro hole (not shown) comprises in the preferred embodiment herein described a circular aperture which on both sides continues in two diametrically opposed narrower slits. The cranked portion 27 has in its middle a circularly arched part which is received in the circular aperture of the Euro hole, whereas the shoulders 27a, 27b adjoining the arched middle part extend into the slits adjoining the circular aperture on the sides. The Euro hole has at its upper edge a shape which is complementary to the upper edge of the cranked portion 27, thus enabling the desired stabilization of the blister package 24.

Each hook 22 has on its other end, that is, on its end opposite the clip mounting portion 26 on the side opposite its cranked portion 27, a recess 36 for receiving the free end of the cranked portion 27 of a neighboring hook 22, such that each two neighboring hooks 22 of the finite chain 18 form a closed compartment 38 (FIGS. 2 and 4) for accommodating the upper end of a blister package 24, shown in FIGS. 1, 2 and 4. As long as the compartment 38 is closed, it is assured that the blister package 24 cannot be removed. Removal is prevented by positive engagement of the two hooks 22 which form each compartment 38.

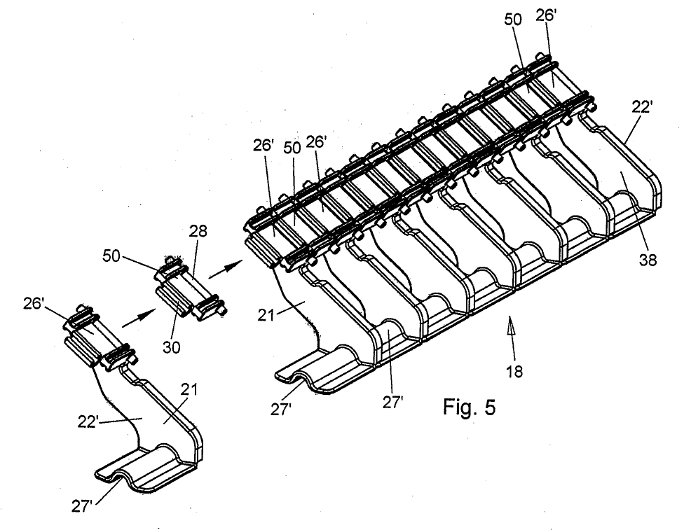

If the blister package transport system 10 shown in FIG. 1 is to handle blister packages 24 which are thicker than the blister packages shown in FIG. 1, allowance could be made for this in that not every compartment 38 accommodates the upper end of a blister package 24 but, for example, only every second or third compartment 38. This would result however in poor utilization of the capacity of the chain 18 because the chain would contain unused hooks 22. For handling thicker blister packages 24, it is more suitable to make use of a second preferred embodiment of hooks 22′, which is shown in FIG. 5 in which like reference numbers are used for like parts as in FIG. 4.

A chain 18 with a larger pitch designed for thicker blister packages 24 requires not only hooks 22′ with a longer cranked portion 27′ but also the use of links 50. The reason for this will be explained in more detail further below. Each link 50 is constructed like a clip mounting portion 26′. The clip mounting portion 26′ is constructed like the clip mounting portion 26 whose design was described in detail above. However, in the second preferred embodiment of the hook 22′, which is shown in FIG. 5, a clip mounting portion 26′ projects beyond the hook element 21 on the side on which the cranked portion 27′ is situated. This becomes readily apparent from a comparison of the hook 22 shown in FIG. 4 on the left with the hook 22′ shown in FIG. 5 on the left. The link 50 is constructed like the clip mounting portion 26′, hence in the representation of FIG. 5 it has the slotted bushing 30 on the left and the guide pin 28 on the right. Otherwise the embodiment according to FIG. 5 corresponds to the embodiment of FIG. 4. One link 50 is clipped in between each two hooks 22′ in their clip mounting portions 26′. The dimension of the link 50 in the longitudinal direction of the chain 18 is adapted to the dimension of the cranked portion 27′ in the longitudinal direction of the chain 18, such that closed compartments 38 are formed by neighboring hooks 22′ also in the embodiment of the chain according to FIG. 5. The hooks 22′ with the long cranked portions 27′ and the links 50 can be joined together to form a finite chain 18 just as simply as the hooks 22 with the short cranked portions 27.

In the following, the construction of the casing 40 and its co-action with the chain 18 will be described in more detail.

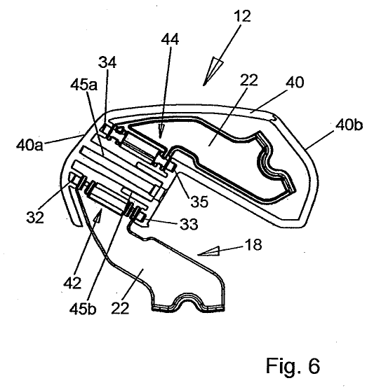

The boom 12 according to FIG. 1 is shown in FIG. 6 in a cross-sectional view. The boom 12 includes the casing 40 which is constructed as a hollow body open in downwards direction. Formed in the casing 40 in the region of the lower opening from which the chain 18 protrudes is a lower groove section 42 for the linear guidance of the chain 18 in the direction of the free end 16 (FIG. 1) of the boom 12. The lower groove section 42 comprises the two lower guide grooves 32 and 33. One of the two guide grooves 32, 33 can be omitted if the remaining guide groove is constructed as a channel with a C-shaped cross-section which has a narrow opening facing the inside of the casing 40. In this case, it would also be necessary for the assigned guide journal 28a or 28b to be constructed with a T-shaped cross-section for it to be guided in the remaining C groove such that the hooks 22 retain their orientation shown in FIG. 6. In this case, it would be more difficult however to guide the chain 18 slidingly in the shown orientation of the hooks 22 as easily and friction-free with one guide groove as with two guide grooves 32 and 33.

Adjoining the lower groove section 42 at the free end of the boom 12 is a turning point 43 (FIG. 10) of the chain 18 at which the blister packages 24 between neighboring hooks 22 are released because the hooks are separated from each other at the turning point 43 as becomes apparent from the representation of FIGS. 1-2 on the left. The lower guide grooves 32, 33 are routed over the turning point 43 and continue in an upper groove section 44 in the upper guide grooves 34 and 35, respectively, which extend back in the direction of the mounting end 14 (FIG. 10) of the boom 12.

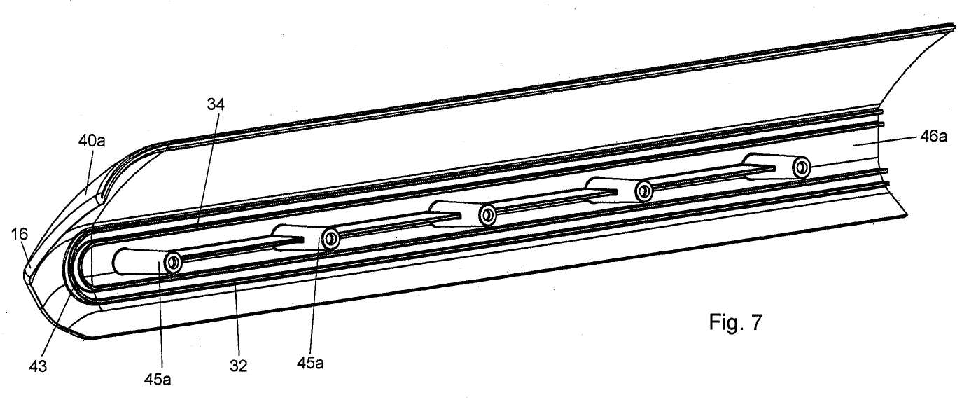

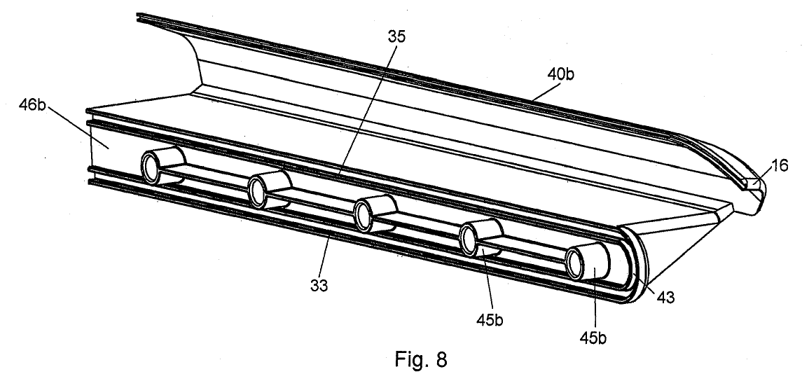

The casing 40 is split longitudinally and constructed of two shells 40a and 40b, as best shown in FIGS. 6 and 9. The shells 40a, 40b of the casing 40 have means 45 for being plug-connected to each other. These means 45 comprise several pairs of pegs 45a and bushings 45b which, like the guide grooves 32, 34 and 33, 35 and the turning point 43, are formed on the inner side of opposed longitudinal walls 46a and 46b, respectively (FIGS. 7-8), of the casing 40. The two casing shells 40a, 40b are moved during assembly into the position shown in FIG. 9 and plugged together in the direction of an arrow 87, whereby each peg 45a is inserted into the assigned bushing 45b and held clamped therein. As the result, the two casing shells 40a, 40b are in precisely mated relationship to each other. Following the assembly of the two casing shells 40a, 40b, the shells form a stable profile with mutually aligned guide grooves 32, 33 below and guide grooves 34, 35 above, in which the chain 18 is exactly orientated in the longitudinal and transverse directions. For the chain 18 there is therefore a lower, open channel for the advance movement of the chain 18 in the direction of an arrow 88 (FIG. 2) and an upper, closed channel for the return movement of the chain 18 in the direction of an arrow 89 (FIG. 2). The two casing shells 40a, 40b, which are manufactured preferably as injection molded parts, can be manufactured in different lengths by means of a variable-length injection mold.

The boom 12 has a supporting arm 52 (FIG. 10) for supporting the casing 40, which supporting arm can be mounted on a vertical wall or the like. Fitted to one end of the supporting arm 52 is a mounting plate 54 with which the supporting arm 52 can be fastened to the wall. In the preferred embodiment shown, the supporting arm 52 is an angular section which is matingly received in a complementary recess in the bottom side of the casing 40 where it can be screw-connected to the casing 40, for which purpose bores 53 and 55, respectively, are provided.

The clip mounting portions 26, 26′ of the hooks 22, 22′ are arranged at an angle to the cranked portions 27,27′ of the hooks, as best shown in FIGS. 3a-5. The guide groove pairs 32,33 and 34, 35 have the same angle of inclination relative to the horizontal, as becomes apparent from FIG. 6. The casing 40 has a low overall height as the result, but nevertheless the cranked portions 27, 27′ of the hooks 22, 22′ are guided in a horizontal orientation.

The operation of the blister package transport system 10 is as follows:

According to the representation of FIGS. 4-5, a hook chain 18 is formed from hooks 20 with a short cranked portion 27 or from hooks 20′ with a long cranked portion 27′ and additional links 50. Clipping together the individual hooks without links 50 or the individual hooks 22′ with links 50 produces a chain 18 which can be handled outside the casing 40 and can be assembled automatically and prefabricated as a module. During final assembly, the chain can be pushed simply from the mounting end 14 into the lower groove section 42 or the upper groove section 44 of the boom 12 before the boom 12 is mounted on the supporting arm 52. In this process, the prior assembled chain 18 is introduced with its guide journals 28a, 28b into the lower guide grooves 32, 33 or into the upper guide grooves 34, 35. Ultimately, the chain 18 extends from the mounting end 14 to approximately the middle of the turning point 43. It is assumed that it then finds itself in the upper groove section 44. The first or last compartment 38 of the chain 18 is then open in the region of the turning point 43 but one hook 22, for example, the hook 22 which in FIG. 2 above has passed the turning point 43, covers the inlet opening of the casing 40 in the upper area so that it is impossible for a hand to reach inside and manipulate, for example, an electronic device situated there (described further below). A blister package 24 is pushed onto the cranked portion 27 and the chain 18 is advanced by one pitch into the lower groove section 42. As soon as the next open compartment 38 arrives at the turning point 43, the next blister package 24 is hung in and the chain 18 advanced further, etc. This procedure is repeated until the maximum possible or desired number of blister packages 24 are suspended upon the chain 18, as is shown in FIG. 1. Owing to the special shape of the hooks 22, the blister packages 24 suspended from the chain 18 are held securely and can be individually removed only at the free end 16 of the boom 12, that is, from the front at the head of the blister package transport system 10. When the front-most blister package 24 is pulled out, the entire chain 18 is advanced by one pitch. As the result, the blister packages 24 suspended further to the rear move forwards in step with the removal until the chain is completely empty. This advancing movement of the chain by one blister package after another is indicated in FIG. 1 by an arrow 90 and in FIG. 2 by arrows 88, 86, and 89. An opening of the compartments 38 takes place only in the region of the turning point 43. Only here is a non-destructive removal of the blister packages 24 possible. If an attempt is made to remove more than one blister package 24 at a time, the blister package transport system 10 will be blocked mechanically, preventing any further movement of the chain 18. The opening of the compartments 38 in the region of the turning point 43 becomes apparent from FIG. 1 and even better so from FIG. 2.

The links 50, which are used when hooks 22′ with the longer cranked portion 27′ are used, are required because of the small curvature radius at the turning point 43 on account of the shallow casing 40. A chain link pitch of the chain 18 as large as the hook 22′ with the long cranked portion 27′ would require a larger curvature radius at the turning point 43 and hence a casing 40 with a larger overall height. As the result, the two casing shells 40a, 40b would be bigger, which could have an adverse effect on the looks of the blister package transport system 10. The hooks 22′ with the long cranked portions 27′ and the links 50 can be joined together to form the finite chain 18 just as simply as the hooks 22 with the short cranked portions 27 for which no links 50 are required. The links 50 compensate for the length difference from hook to hook without affecting the actual pitch of the chain 18 with regard to the small curvature radius at the turning point 43. When using the links 50, the chain 18 thus has the short pitch in the guide in the upper groove section 44 but the long pitch in the guide in the lower groove section 42. As the turning point of the free end of the cranked portion 27′ does not change in relation to the short cranked portion 27, the hooks 22′ with the long cranked portions 27′ can also be deflected in the casing shells 40a, 40b whose dimensions orientate themselves by the chain 18 with the hooks 22 having short cranked portions 27.

The modular design of the blister package transport system 10 enables an electronic control board to be accommodated within the boom 12. The electronic equipment upgrades the normal mechanical functions into a practically intelligent blister package transport system. The electronic control board (not shown) could be accommodated between the lower groove section 42 and the upper groove section 44 in the casing 40, for example in a plane between the plug-in connection means 45. Furthermore, using a return run sensor accommodated in the proximity of the mounting end 14 in the casing 40, it would be a very simple matter to check when the blister package transport system 10 is nearly empty. This return run sensor would detect when the first hook 22 or 22′ of the chain 18 arrives in the upper groove section 44 in the vicinity of the mounting end 14 and hence when the chain 18 is empty or nearly empty. The electronic version can also be constructed in a more intelligent form by placing a sales sensor in the region of the turning point 43 between the lower groove section 42 and the upper groove section 44. This sensor would monitor the continuous sales and signal them directly to a higher-level system. This would make it possible, for example, to draw up simultaneous inventories. Also it would be possible with the help of the sensors to perform a plausibility check in order to record deviations from customer purchasing behavior (theft). In this case an electronic control device could activate an electromechanical lock which blocks the blister package transport system 10 and prevents any further theft. Solely by virtue of its mechanical construction and modular design does the blister package transport system 10 guarantee a neat shelf profile. But with the previously described additional electronic control device the blister package transport system 10 can be expanded to include an intelligent merchandise sales control system. Furthermore, the blister package transport system 10 makes it superfluous to present merchandise in glass cases, automatic dispensing machines and the like and to package the products in addition in security boxes, thus providing consumers with direct access to a product and saving retailers the expense of an additional security box. In addition, the electronic device can be configured so that the removal of merchandise is possible only during business hours, meaning that the removal of merchandise outside shop opening times is blocked.

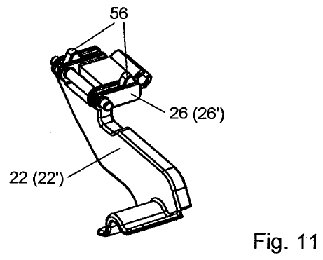

FIG. 11 shows a third preferred embodiment of the hook 22 or 22′ in which the hook is equipped with two switching cams 56 for actuating a motion detector 57 (indicated in FIG. 2). The two switching cams 56 are integrally formed on the clip mounting portion 26 or 26′ in spaced relation transverse to the longitudinal direction of the chain 18 and in offset relation in the longitudinal direction of the chain 18. With the switching cams 56 it is possible for two actuating arms of a motion detector 57 (one actuating arm thereof being indicated in FIG. 2 by a dashed line) to be actuated, as a result of which certain control combinations result, depending, for example, on the direction of movement of the chain 18, with which certain states of the chain 18 can be detected, for example its advancing or return movement, the end of the chain, etc. In FIG. 2 only one switching cam 56 is indicated, but it will be understood, of course, that each hook 22 or 22′ of a chain is equipped with at least one and preferably two such switching cams 56. Conveniently, the links 50 can also be equipped with at least one switching cam 56. The combination of switching cam 56 and motion detector 57 can be used alone or in combination with the above described electronic control device.

Although a blister package transport system is described with reference to the accompanying FIGS. 1-11 as a preferred embodiment of the transport system according to the invention, it will be understood that the transport system is suitable not only for blister packages but for all types of merchandise which can be suspended from the hooks 22 or 22′ of the chain 18.

### List of Reference Numbers

10 blister package transport system
12 boom
14 mounting end
16 free end
18 chain
20 chain link
21 hook element
22, 22′ hook
24 blister package
26, 26′ clip mounting portion
27 short cranked portion
27′ long cranked portion
27a, 27b lateral webs
28 guide pin
28a, 28b guide journal
30 slotted bushing
32 lower guide groove
33 lower guide groove
34 upper guide groove
35 upper guide groove
36 recess
38 compartment
40 casing
40a, 40b shells
42 lower groove section
43 turning point
44 upper groove section
45 plug-in connection means
45a peg
45b bushing
46a, 46b longitudinal walls
50 link
52 supporting arm
53 bore
54 mounting plate
55 bore
56 switching cam
57 motion detector
86-90 arrows

While the invention has been described in detail and with reference to specific examples thereof, it will be apparent to one skilled in the art that various changes and modifications can be made therein without departing from the spirit and scope thereof.

What is claimed is:

1. A transport system for blister packages or the like, said system comprising:
a chain comprising chain links, each of which are constructed as a hook for suspending a blister package or the like thereon;
a boom having a mounting end for mounting on a fixed structure and having a free end opposite thereto, said boom comprising an upper groove section and a lower groove section, said lower groove section supporting movement of said chain towards said free end of said boom and a chain turning point, formed at said free end, and said upper groove section supporting movement of said chain away from said turning point towards said mounting end; and
wherein said chain is manually manipulatable such that a single blister pack or the like is removable from its corresponding hook, by a consumer, only at said turning point causing said chain to advance and wherein new blister packs or the like are coupled to said hooks in said upper groove section and are manually advanced into said lower groove section.

2. The transport system according to claim 1 wherein said boom comprises a casing formed as a hollow body open in a downward direction and wherein said casing comprises an inner side including lower guide grooves corresponding to said lower groove section and upper guide grooves corresponding to said upper groove section.

3. The transport system according to claim 2 wherein said casing is split longitudinally, forming two shells.

4. The transport system according to claim 3 wherein said shells of said casing comprise means for a mutual plug-in connection.

5. The transport system according to claim 2 wherein said boom includes a supporting arm mountable on the fixed structure, for the casing.

6. The transport system according to claim 1 wherein each chain link and its hook element are constructed as a single-piece hook.

7. The transport system according to claim 6 wherein each hook has on one end a clip mounting portion adapted to be clipped into clip mounting portions of two neighboring hooks.

8. The transport system according to claim 7 wherein each clip mounting portion has a guide pin and, parallel and complementary thereto, a slotted bushing into which said guide pin of a neighboring hook can be clipped.

9. The transport system according to claim 8 wherein each guide pin has at either end protruding guide journals for being received in respective guide grooves.

10. The transport system according to claim 7 wherein each hook comprises a portion cranked on one side.

11. The transport system according to claim 10 wherein lateral webs are formed on said cranked portion.

12. The transport system according to claim 10 wherein each hook has at an upper end on a side opposite its cranked portion a recess for receiving the free end of said cranked portion of a neighboring hook, wherein each two neighboring hooks of said finite chain are able to form in combination a closed compartment for accommodating an upper end of a blister package or the like.

13. The transport system according to claim 9 wherein said hooks are guided at an angle through said guide grooves and that on each hook said clip mounting portions are set at a corresponding angle relative to said cranked portion.

14. The transport system according to claim 7 further comprising separate links each of which are constructed like every clip mounting portion.

15. The transport system according to claim 1 wherein each hook is equipped with at least one switching cam for actuating a motion detector.
